(19) United States
(12) Patent Application Publication
(10) Pub. No.: US 2025/0079144 A1
(43) Pub. Date: Mar. 6, 2025

(54) APPARATUS AND METHOD FOR TRANSMITTING GASEOUS IONIC SAMPLE MATERIAL FOR SUBSEQUENT ANALYSIS

(71) Applicant: Bruker Daltonics GmbH & Co. KG, Bremen (DE)

(72) Inventor: Benjamin BIRNER, Bremen (DE)

(21) Appl. No.: 18/816,156

(22) Filed: Aug. 27, 2024

Related U.S. Application Data
(60) Provisional application No. 63/580,124, filed on Sep. 1, 2023.

(51) Int. Cl. H01J 49/04; G01N 27/622; H01J 49/06

(52) U.S. Cl. CPC H01J 49/0422; G01N 27/622; H01J 49/062

(57) ABSTRACT

The present disclosure relates to an apparatus for transmitting gaseous ionic sample material for subsequent analysis, in particular mass analysis, comprising: a first vacuum chamber through which ionic sample material is guided, the first vacuum chamber being kept in a first pressure range, a second downstream vacuum chamber through which ionic sample material is guided, the second downstream vacuum chamber being kept in a second pressure range which is substantially higher than the first pressure range, and a first gas inlet assembly located substantially at the second vacuum chamber and designed and configured to introduce gaseous matter, which does not originate from the first vacuum chamber, directedly into the second vacuum chamber. The present disclosure relates further to a corresponding method for transmitting gaseous ionic sample material for subsequent analysis, in particular mass analysis.

### BACKGROUND OF THE INVENTION

### Field of the Invention

The present disclosure relates to apparatuses, devices, assemblies, and methods generally used in the field of mass analysis and mass spectrometry.

### Description of the Related Art

The Prior Art is explained hereinafter with reference to a special aspect. However, this should not be construed as limiting the invention disclosed below. Useful further developments and modifications of what is known from the Prior Art may also be applicable beyond the comparatively narrow scope of this introduction and will become readily apparent to skilled practitioners in the field after reading the disclosure of the invention following this introduction.

With reference to FIG. 1, in its simplest form, a mass spectrometer may be described to comprise an ionizing portion (A) in which a sample of arbitrary or generic nature is transferred into the gas-phase, if not already gaseous such as an eluent from a gas chromatograph or a headspace sample, and ionized. Examples for ionization mechanisms are electrospraying, matrix-assisted laser desorption/ionization (MALDI), electron ionization, and photoionization, to name but a few.

Downstream from the ionizing portion (A), there may be located an ion manipulating, selecting, separating or fragmenting portion (B). Manipulation may be effected by mechanisms such as collisional cooling and radial focusing/collimation; selection may be possible with a mass filter or ion trap; separation may be implemented using an ion mobility analyzer, for instance; and fragmentation may be brought about by collision induced dissociation, charge transfer induced fragmentation or photo-induced fragmentation, as a skilled practitioner sees fit.

After the manipulating, selecting, separating or fragmenting portion (B), there is located an analyzing portion (C) that may operate according to principles such as time-of-flight, cyclotron resonance, RF driven stability-instability, and the like. In some implementations, the function of the ion manipulating, selecting, separating or fragmenting portion (B) and that of the analyzing portion (C) can be combined in one device in the mass spectrometer, sometimes called tandem-in-time approach as compared to the tandem-in-space one as with a triple quadrupole mass analyzer, for instance.

A detecting portion (D) after the analyzing portion (C) acquires data representative of the ion current under investigation and allows deriving its composition. The detecting portion (D) may comprise elements such as dynodes and microchannel plates (destructive or consuming type of detection) or pick-up electrodes for image currents (non-destructive or non-consuming type of detection), for example. As all these afore-mentioned portions in a mass spectrometer may be located in different pressure regimes, ion transmission between these portions can be considered to be of major importance for the functioning of the mass spectrometer.

Various components along the ion path in a mass spectrometer from the ion source region until the final detector, which is often located in a mass analyzer, may have to be held at different pressure levels. While it may be preferable to establish a monotonously decreasing pressure level along the ion path in order to promote the propagation of gaseous ionic matter in this direction by virtue of the drag of a substantially continuous gas flow acting on the ionic matter, it is possible that certain intermediate stages along the ion path have to be kept at higher pressure level than neighboring upstream and/or downstream vacuum stages. Examples of such spatially variable pressure profile are caused, e.g., by intermediate ion mobility separators and fragmentation cells using collision induced dissociation which are often located sandwiched between two devices that operate at lower pressure levels in relation thereto, such as an ion trap, a mass filter or a mass analyzer.

Having a vacuum stage at higher pressure level neighbored by two vacuum stages at lower pressure levels in relation thereto entails a flow of gas following the pressure gradient from high pressure to low pressure. While such effect may be beneficial at the interface of the high-pressure vacuum stage and the subsequent low-pressure vacuum stage, as it imparts additional momentum to ionic matter leaving the high-pressure vacuum stage in the downstream direction, it may also be a hindrance for ionic matter entering the high-pressure vacuum stage from the preceding low-pressure vacuum stage, since the counterflow of gas tends to slow ionic matter down, push it back and disperse it. It is possible to overcome these counterforces by adequately applied electric potentials at the corresponding interface. Nonetheless, the counterflow of gas may lead to spatial broadening and momentum dispersal of the ionic matter upon entry into the downstream stage, which may be undesirable as it can hinder further handling of the ionic matter. In the worst case it can lead to loss of ionic matter, for example, when the interface between upstream low-pressure vacuum stage and high-pressure vacuum stage comprises comparatively small apertures, openings or orifices, such as with transfer capillaries.

The following publications provide additional insight into the technical background of the present disclosure, without claiming completeness:

The article by Vyacheslav N. Fishman et al. (International Journal of Mass Spectrometry 177 (1998) 175-186) pertains to simplified injector flanges for selected ion flow tubes.

The study by D. J. Douglas et al. (J Am Soc Mass Spectrom 1992, 3, 398-408) reports about collisional focusing effects in radio frequency (RF) quadrupoles. In the same vein does the patent U.S. Pat. No. 4,963,736 by the same authors/inventors relate to a mass spectrometer and method of improved ion transmission.

The patent application publication US 2012/0228492 A1 relates to ions guided by gas flows in mass spectrometers, particularly in RF multipole systems, and to RF quadrupole mass filters and their operation with gas flows in tandem mass spectrometers.

The patent U.S. Pat. No. 9,437,410 B2 discloses a system of mass spectrometry having an ion source for generating ions at substantially atmospheric pressure. The system has a sampling member with an orifice disposed therein. The sampling member forms a vacuum chamber with a mass spectrometer. The system also has a curtain plate between the ion source and the sampling member. The curtain plate has an aperture therein, having a cross-section and being spaced from the sampling member to define a flow passage between the curtain plate and the sampling member, and to define an annular gap between the orifice and the aperture. The area of the annular gap is less than the cross-sectional area of the aperture. The system also has a power supply for applying a voltage to the curtain plate, and a curtain gas flow mechanism for directing a curtain gas into the flow passage and the annular gap.

The patent application publication US 2016/0351382 A1 discloses a method for coupling a first chamber of a mass spectrometer or ion mobility spectrometer containing a first gas and a second chamber containing a second gas. The method comprises providing an intermediate region between the first and second chambers that is operated at a lower pressure to substantially prevent or reduce ingress of the first gas into the second chamber and/or of the second gas into the first chamber.

The patent application publication US 2020/0381241 A1 relates to hybrid IMS/MS systems (IMS=ion mobility separator, MS=mass spectrometer) and provides hybrid IMS/MS system comprising an RF funnel, an ion mobility analyzer and a mass analyzer wherein the RF funnel is arranged non-collinearly to the ion mobility analyzer, preferably a TIMS analyzer (TIMS=trapped ion mobility spectrometry).

The review by Tom Covey (Rapid Commun Mass Spectrom. 2022; e9354) discusses the genesis of sensitivity gains of atmospheric pressure ionization triple quadrupole (API-QqQ) systems using electrospray ionization (ESI) on the order of one-million-fold over the past decades and nearly the same gains for atmospheric pressure chemical ionization (APCI), another major method of producing ions at atmospheric pressure.

In view of the foregoing, there is still a need for improved ion transmission in a mass spectrometer assembly. Further objectives to be achieved may readily be recognized by the person having ordinary skill in the art upon reading the following disclosure.

### SUMMARY OF THE INVENTION

In a first aspect, the present disclosure relates to an apparatus for transmitting gaseous ionic sample material for subsequent analysis, comprising:—a first vacuum chamber encompassing a first entrance through which gaseous matter including ionic sample material is introduced, a first exit through which gaseous matter including ionic sample material leaves, and one or more first RF ion guides for receiving and guiding ionic sample material along its way from the first entrance to the first exit, the first vacuum chamber being kept in a first pressure range,—a second vacuum chamber encompassing a second entrance through which gaseous matter including ionic sample material leaving the first vacuum chamber is introduced, the second entrance being fluidically coupled to the first exit and defining an axis, a second exit through which gaseous matter including ionic sample material leaves, and one or more second RF ion guides for receiving and guiding ionic sample material along its way from the second entrance to the second exit, the second vacuum chamber being kept in a second pressure range which is substantially higher than the first pressure range, and—a first gas inlet assembly located substantially adjacent to the second entrance and designed and configured to introduce gaseous matter, which does not originate from the first vacuum chamber, in a direction substantially along the axis into the second vacuum chamber.

The gaseous matter being introduced by the first gas inlet assembly may be a chemically inert or inactive gas or mixture of such gases, for example, chosen from among the group including: molecular nitrogen, Helium, Argon, sulfur hexafluoride, and the like. The introduced gaseous matter may, in particular, be electrically neutral. The gaseous matter may be injected at temperature levels of between equal to or less than 473 Kelvin (˜200° C.) and equal to or more than a liquefaction temperature of the gas species under consideration, for example, for nitrogen about 77 Kelvin at atmospheric pressure. Particularly preferred may be a temperature of the additional gaseous matter introduced into the second vacuum chamber by the first gas inlet assembly of about room temperature (293-298 Kelvin or ˜20-25° C.). The purity grade of gaseous matter may be N4.0 or higher, such as N5.0, N6.0 and any other suitable purity grade.

A vacuum chamber may be an enclosure having a predetermined degree of gastightness or hermetic sealing against the ambience or environment. A vacuum chamber may be fluidically connected to a source of vacuum, such as a pump. Despite being gastight or sealed off, a vacuum chamber may accept certain amounts of gas load, such as through an entrance, and may be designed and configured to pass on a certain amount of gas load, such as through an exit or a venting or exhaust port. Such gas load may generally comprise electrically neutral or inert or inactive gaseous matter and/or ionic sample material. Ionic sample material may be matter derived from a biological source, such as a bodily fluid like whole blood, blood plasma, lymphatic fluid, spinal fluid, and the like. Broken down to the molecular level, ionic sample material of interest may be chosen from among the group including: proteins, peptides, lipids, polysaccharides, nucleotides, metabolites, and the like. Ionic sample material may also be derived or extracted from any kind of ambient or environmental source, such as from any gas, liquid or condensed phase body found in the ambience or environment. A particular example for ionic sample material of interest, on a molecular level, would be a chlorofluorocarbon (CFC), such as trichlorofluoromethane (R-11), bromochlorodifluoromethane (R-12B1), and carbon tetrachloride (CCl₄).

In various embodiments, the first gas inlet assembly may encompass one or more nozzles. Preferably, the one or more nozzles may encompass one of (i) a plurality of individual nozzles and (ii) an annular or ring-shaped nozzle. Further preferably, the plurality of individual nozzles may be aligned such that gaseous matter is introduced at an angle of less than 60° to the axis. The angle of introduction in relation to the axis may generally vary between about 60° and 0°, where 0° indicates parallel alignment of the nozzle(s) with the axis. An angle of introduction of between 45° and 0° may be particularly preferred. Generally, the angle of introduction in relation to the axis may be chosen from among the group including: 60°, 55°, 50°, 45°, 40°, 35°, 30°, 25°, 20°, 15°, 10°, 5°, 0°, as well as any other angle between 0° and 60°, and in particular between 0° and 45°.

In alternative embodiments, the first gas inlet assembly may encompass a manifold disk, accommodated at an interface of the first vacuum chamber and the second vacuum chamber, and having an embedded gas channel running from a substantially peripheral portion of the manifold disk to a substantially central portion of the manifold disk where the embedded gas channel discharges through one or more openings into a first region substantially close, near or proximate to a first side face of the manifold disk, wherein the manifold disk comprises a substantially central orifice for allowing gaseous matter and ionic sample material to pass from a second region substantially close, near or proximate to a second side face of the manifold disk to the first region substantially close, near or proximate to the first side face of the manifold disk, and wherein gaseous matter, not originating from the first vacuum chamber, is ejected through the one or more openings into the second vacuum chamber. The manifold disk may be designed and constructed according to principles as disclosed in the patent application publication US 2016/0086784 A1, which is incorporated by reference herein in its entirety. The manifold disk may have a thickness on the order of 2 millimeters, 3 millimeters, 4 millimeters, 5 millimeters and the like.

In various embodiments, the first gas inlet assembly may be designed and configured to introduce gaseous matter substantially one of (i) coaxially and (ii) concentrically with the axis. Such embodiment may serve to establish a gas flow within the second vacuum chamber which is substantially free of turbulence, or which loses any degree of turbulence it may have upon introduction of electrically neutral or chemically inert or inactive gaseous matter a short distance from the point of introduction within the second vacuum chamber.

In various embodiments, the apparatus may further comprise one or more transfer tubes or capillaries fluidically coupling the second entrance with the first exit. The one or more transfer tubes or capillaries may have a lateral extension which is configured and dimensioned such that it allows mounting the first gas inlet assembly substantially adjacent and close to the second entrance. The one or more transfer tubes or capillaries may include a spatial constriction between the first vacuum chamber and the second vacuum chamber and allow a first gas inlet assembly to be mounted in a space left open by such constriction. The volumes of both the first vacuum chamber and the second vacuum chamber may stay unaffected by such spatially optimized design. In alternative embodiments, the second entrance and the first exit may be fluidically coupled by one or more openings, apertures or orifices situated at corresponding positions of the first vacuum chamber and second vacuum chamber, respectively. The axis may be defined as a line running through a center of such opening, aperture or orifice and being aligned perpendicularly to an area of the corresponding opening, aperture or orifice.

In various embodiments, the first pressure range may be on the order of 10⁻¹ millibar, 10⁻² millibar and less, and the second pressure range may be a single digit-millibar range situated between 0.2 and 50 millibar. A pressure in the second vacuum chamber may comprise a substantially constant pressure gradient with higher pressure in a region at and close to the second entrance and with a lower pressure in a region at and close to the second exit to establish a gas flow within the second vacuum chamber. A pressure gradient within the second vacuum chamber generally from the second entrance to the second exit may span a pressure range of about Δp=1, 2, 3, 4, 5, 6, 7, 8, 9 millibar, or any other value between 1 and 9 millibar.

Gaseous matter may be introduced into the second vacuum chamber by the first gas inlet assembly at a flow rate chosen from among the group including: 0.1 L/min, 0.2 L/min, 0.3 L/min, 0.4 L/min, 0.5 L/min, 0.6 L/min, 0.7 L/min, 0.8 L/min, 0.9 L/min, 1.0 L/min, 1.5 L/min, 2.0, L/min, 2.5 L/min, 3.0 L/min, 3.5 L/min, 4.0 L/min, 4.5 L/min, 5.0 L/min, and any other value between 0.1 L/min and 5.0 L/min. The value range between 0.5 L/min and 1.0 L/min may be particularly preferred. Volume flows presented here are to be understood at standard temperature and pressure (STP; T₀=˜273 Kelvin, p₀=1000 millibar).

In various embodiments, the one or more second RF ion guides may encompass one or more ion mobility separators. In particular, the one or more second RF ion guides may comprise one or more field-asymmetric ion mobility separators (FAIMS). FAIMS works generally by applying a high-voltage asymmetric waveform at radio frequency (RF) combined with a static (DC) waveform between two electrodes. The RF waveform creates a high-field environment for a short time span, followed by a low-field environment for a longer time span. The DC waveform creates a compensation field that balances the ionic sample material drift caused by the RF waveform. Ionic sample material with different mobilities in high and low fields will have different net displacements after one period of the waveform. By adjusting the DC compensation field, ionic sample material with different mobilities may be selectively transmitted or filtered out of the device. The transmitted ionic sample material may then be detected in a mass analyzer.

In various embodiments, the one or more ion mobility separators may encompass one or more trapped ion mobility separators (TIMS). TIMS works generally by applying an electric field gradient that holds ionic sample material stationary against a moving gas flow. The moving gas flow may drive ionic sample material forward, such as in a direction from the second entrance to the second exit of the second vacuum chamber. The electric field strength may vary along the length of the device, creating a correlation between collision cross section or mobility of ionic sample material and its equilibrium position. By changing the electric field strength over time, ionic sample material with different mobilities may be released from the device in a sequential order. The released ionic sample material may then be detected in a mass analyzer. Examples of embodiments of TIMS may be found in the patent U.S. Pat. No. 7,838,826 B1, which is incorporated by reference herein in its entirety.

In various embodiments, the one or more second RF ion guides may encompass a substantially gastight design. Such design allows transmitting a gas flow through the one or more second gastight RF ion guides from an end where gaseous matter ingresses to an end where gaseous matter egresses without any substantial loss of gaseous matter, thus keeping a mass balance within the one or more second RF ion guides substantially stable. In a particular embodiment, the one or more second RF ion guides encompassing substantially gastight design may be attached and/or mounted and/or fixed to the second entrance of the second vacuum chamber in a substantially gastight manner. In so doing, the one or more second RF ion guides encompassing substantially gastight design may implement the functionalities of guiding ionic sample material and embodying the second vacuum chamber at the same time. Having no separate vacuum enclosure surrounding or containing the one or more second RF ion guides, in such example, may facilitate a compact design of, and may significantly reduce pumping requirements for the second vacuum chamber.

In various embodiments, the apparatus may further comprise a mass balance system being operated such that a mass balance of gaseous matter being introduced into the second vacuum chamber is maintained to generate a substantially continuous or steady flow of gaseous matter within the second vacuum chamber. Preferably, the substantially continuous or steady flow of gaseous matter may be one of (i) section-wise and (ii) completely substantially laminar along its way within the second vacuum chamber. Further preferably, the substantially continuous or steady flow of gaseous matter may be generated within the one or more second RF ion guides. In particular, the substantially continuous or steady flow of gaseous matter may be generated within a trapped ion mobility separator located within the second vacuum chamber. The mass balance system may operate one or more sources of vacuum, such as one or more pumps fluidically connected to the second vacuum chamber.

In various embodiments, the one or more second RF ion guides may encompass one or more ion guides which have at least one of (i) an RF funnel design and (ii) an RF tunnel design. An RF funnel may focus and transport a beam of ionic sample material from one pressure region to a subsequent or downstream pressure region. An RF funnel may include a series of ring electrodes with decreasing inner diameters, which can be connected to an RF voltage generator and a DC voltage source. The RF voltage may create an oscillating electric field that traps and confines ionic sample material radially, while the DC voltage may create a static electric field that pushes ionic sample material axially. The RF voltage generator and/or the DC voltage source may be tunable to allow for flexibility of guiding conditions of ionic sample material.

In various embodiments, the one or more second RF ion guides may encompass one or more stacked ring ion guides. Stacked ring ion guides may be well suited for establishing an electric potential gradient along their longitudinal extension to drive or propel ionic sample material. For this purpose, a plurality of the rings in the stack or each ring in the stack may be connected to one or more tunable sources of RF and DC voltages.

In various embodiments, the first vacuum chamber may encompass one or more venting ports for extracting excess gaseous matter. The one or more venting ports may be fluidically connected to a source of vacuum, such as one or more pumps, in order to establish and substantially maintain a predetermined first pressure range within the first vacuum chamber.

In various embodiments, the one or more first RF ion guides may encompass at least one of (i) a stacked ring ion guide and (ii) an RF multipole assembly. Preferably, the stacked ring ion guide may encompass one or more electrode rings having multipolar design, such as chosen from among the group including: quadrupolar design, hexapolar design, octopolar design, and any other order of multipolar design and also any superpositions thereof. Examples of such multipolar design may be found in the patent application publication US 2006/0108520 A1, which is incorporated by reference herein in its entirety. Further preferably, the RF multipole assembly may encompass one or more segmented multipole rods. Segmenting of multipole rods allows establishing an electric potential gradient along the longitudinal extension of the RF multipole assembly, for instance, to drive or propel ionic sample material in a desired direction.

In various embodiments, the RF multipole assembly may encompass one or more additional electrodes to establish an electric potential gradient along its length. The one or more additional electrodes may be supplied with one or more DC voltages and may further be located such at the corresponding RF multipole assembly that the one or more DC voltages take effect on an electric field condition inside the RF multipole assembly through gaps in between the pole rods or electrodes of the RF multipole assembly.

In various embodiments, at least one of (i) the one or more first RF ion guides and (ii) the one or more second RF ion guides may be substantially aligned along the axis. The axis may be one of linear, straight, non-linear and curved. The axis may be a common axis defined by the second entrance and the first exit.

In various embodiments, one or more electric potentials may be applied to at least one of (i) the one or more first RF ion guides and (ii) the one or more second RF ion guides, such that ionic sample material is driven in a direction substantially from the first vacuum chamber to the second vacuum chamber. Such measure may be taken to reduce the propensity of backflow of ionic sample material.

In various embodiments, the apparatus may further comprise one or more trapping diaphragms or lenses being located in the first vacuum chamber at least one of at (i) the first entrance, (ii) the first exit, and (iii) a position between the first entrance and the first exit, the one or more trapping diaphragms or lenses being temporarily supplied with one or more electric trapping potentials which substantially hinder the propagation of ionic sample material. In alternative embodiments, the one or more trapping diaphragms or lenses may be supplied with one or more RF voltages to temporarily establish one or more pseudo-potential barriers for ionic sample material of interest.

In various embodiments, the apparatus may further comprise at least one of a (i) mass analyzer and (ii) fragmentation, activation or reaction cell, being in fluidic communication with the second exit. The mass analyzer may be a time-of-flight (TOF) analyzer, such as working with orthogonal acceleration (OTOF) and optionally further comprising one or more reflector stages to extend the flight path and afford for velocity and/or energy focusing of ionic sample material, an ion cyclotron resonance (ICR) analyzer, an analyzer of the Kingdon type, such as the Orbitrap® (Thermo Fisher), a quadrupole mass analyzer, and the like. The fragmentation, activation or reaction cell may work according to a principle chosen from among the group including: collision induced dissociation (CID), electron induced dissociation, such as electron transfer dissociation (ETD) and electron capture dissociation (ECD), photo induced dissociation, such as ultraviolet photo dissociation (UVPD) and infrared multiple photon dissociation (IRMPD), surface induced dissociation (SID), and the like.

In various embodiments, the apparatus may further comprise a third vacuum chamber encompassing a third entrance through which gaseous matter including ionic sample material is introduced, a third exit, being fluidically coupled to the first entrance, through which gaseous matter including ionic sample material leaves, one or more venting ports for extracting excess gaseous matter, and one or more deflectors for redirecting and guiding ionic sample material along its way from the third entrance to the third exit, the third vacuum chamber being substantially kept in a third pressure range which is substantially higher than the first pressure range. Preferably, the apparatus may further comprise an RF funnel fluidically coupling the third exit with the first entrance for guiding and conditioning ionic sample material. Further preferably, the third pressure range may be a single digit-millibar range situated between 0.2 and 50 millibar. The third vacuum chamber may comprise a pressure gradient generally between the third entrance and the one or more venting ports which may span a single-digit millibar range, such as chosen from among the group including: Δp=1, 2, 3, 4, 5, 6, 7, 8, 9 millibar, or any other millibar value in the single-digit range. Further preferably, the third entrance may encompass one or more transfer tubes or capillaries. The third exit may be aligned with the axis defined by the second entrance, and may also be aligned with a common axis defined by the second entrance and the first exit.

In various embodiments, the one or more deflectors may be designed and configured such as to deflect ionic sample material by an angle of more than 45° from a direction of introduction towards the third exit. Preferably, an angle of deflection may be chosen from among the group including: 45°, 50°, 55°, 60°, 65°, 70°, 75°, 80°, 85°, 90° (perpendicular deflection), 95°, 100°, 105°, 110°, 115°, 120°, 125°, 130°, 135°, 140°, 145°, 150°, 155°, 160°, 165°, 170°, 175°, 180° (u-turn deflection), and any other angle in the range from between substantially 45° and 180°. The one or more deflectors may be connected to a DC voltage source or a multitude of DC voltage sources, which may optionally be tunable. A polarity of the electric potentials applied to the one or more deflectors may be chosen such as to have one of repulsive and attractive effect on ionic sample material being introduced into the third vacuum chamber through the third entrance. In alternative embodiments, the one or more deflectors may be connected to an RF voltage source or a multitude of RF voltage sources, which may optionally be tunable, in order to modify a direction of propagation of ionic sample material using one or more pseudo-potentials.

In various embodiments, the third entrance may be in fluidic communication with an ion source. The ion source may generate ionic sample material at substantially atmospheric or ambient pressure (˜1000 millibar), such as an electrospray ion source or chemical ionization source at atmospheric or ambient pressure. The ion source may be accommodated in a chamber which may be gas-dynamically substantially sealed off from the ambience or environment, and which may further be supplied or flushed with clean gaseous matter which may be substantially electrically neutral, chemically inert or inactive, such as molecular nitrogen.

In various embodiments, the apparatus may further comprise a second gas inlet assembly located substantially adjacent to the third exit and designed and configured to introduce gaseous matter into the third vacuum chamber. Injecting gaseous matter, which may in particular be electrically neutral, chemically inert and/or inactive, in a direction substantially opposite to a direction of propagation of ionic sample material along its way from the third entrance to the third exit allows a stripping off of unwanted and undesired gaseous matter, such as mixtures of water and solvents (e.g., volatile organic compounds, in particular, methanol, acetonitrile, and isopropanol) which may be a relic of the ionization process, from the ionic sample material of interest, thus promoting background reduction.

In a further aspect, the present disclosure relates to a method for transmitting gaseous ionic sample material for subsequent analysis, comprising:—introducing gaseous matter including ionic sample material into a first vacuum chamber through its entrance,—receiving and guiding ionic sample material along its way from the entrance to an exit of the first vacuum chamber using one or more first RF ion guides within the first vacuum chamber,—releasing gaseous matter including ionic sample material through the exit of the first vacuum chamber,—in so doing, keeping the first vacuum chamber in a first pressure range,—introducing gaseous matter including ionic sample material being released from the first vacuum chamber into a second vacuum chamber through its entrance, being fluidically coupled to the exit of the first vacuum chamber and defining an axis,—receiving and guiding ionic sample material along its way from the entrance to the exit of the second vacuum chamber using one or more second RF ion guides within the second vacuum chamber,—releasing gaseous matter including ionic sample material through an exit of the second vacuum chamber,—in so doing, keeping the second vacuum chamber in a second pressure range which is substantially higher than the first pressure range, and—introducing gaseous matter, which does not originate from the first vacuum chamber, at a position substantially adjacent to the entrance of the second vacuum chamber in a direction substantially along the axis into the second vacuum chamber.

A velocity of gaseous matter being introduced (by the first gas inlet assembly) at a position substantially adjacent to the second entrance of the second vacuum chamber may be chosen from among the group including: 100 m/s, 200 m/s, 300 m/s, 400 m/s, 500 m/s, 600 m/s, 650 m/s, 700 m/s, 750 m/s, 800 m/s, 900 m/s, 1000 m/s, and any other velocity taken from a range of between 100 m/s and 1000 m/s.

A pressure profile of the first vacuum chamber may have a first pressure level at the entrance to the first vacuum chamber, a second pressure level at the exit of the first vacuum chamber and a third pressure level at a position between the entrance to, and the exit of the first vacuum chamber, wherein the first pressure level is generally higher than the second pressure level and generally substantially higher than the third pressure level, or wherein the third pressure level is generally lower than the second pressure level and generally substantially lower than the first pressure level, or wherein the second pressure level is generally higher than the third pressure level and generally lower than the first pressure level. The first pressure level may generally be on the order of between 0.15 and 0.4 millibar. The second pressure level may generally be on the order of between 0.05 and 0.15 millibar. The third pressure level may generally be on the order of between 0.01 and 0.05 millibar.

All embodiments, explanations and details given above in relation to the apparatus aspect of the present disclosure may likewise and equally be applicable to the method aspect of the present disclosure, as a person having ordinary skill in the art will recognize.

### BRIEF DESCRIPTION OF THE DRAWINGS

The invention can be better understood by referring to the following figures. The elements in the figures are not necessarily to scale, emphasis instead being placed upon illustrating the principles of the invention (often schematically):

FIG. 1 schematically depicts a typical assembly of components in a mass spectrometer.

FIG. 2A schematically presents an ion transmission apparatus operating according to principles of the present disclosure, depicting, in particular, a first design of fluidic coupling between first exit and second entrance.

FIG. 2B schematically presents an ion transmission apparatus operating according to principles of the present disclosure, depicting, in particular, a second design of fluidic coupling between first exit and second entrance.

FIG. 2C schematically presents an ion transmission apparatus operating according to principles of the present disclosure, depicting, in particular, a third design of fluidic coupling between first exit and second entrance.

FIG. 2D schematically presents an ion transmission apparatus operating according to principles of the present disclosure, depicting, in particular, a fourth design of fluidic coupling between first exit and second entrance.

FIG. 3A schematically presents a variant of RF ion guides located in the fine or medium vacuum chamber from FIG. 2A.

FIG. 3B schematically illustrates another variant of RF ion guides located in the fine or medium vacuum chamber from FIG. 2A.

FIG. 4A schematically shows a variant of a gas inlet assembly located at the entrance to the fine or medium vacuum chamber from FIG. 2A.

FIG. 4B schematically depicts another variant of a gas inlet assembly located at the entrance to the fine or medium vacuum chamber from FIG. 2A.

FIG. 5 shows a schematic representation of a possible combined ion mobility-mass spectrometer in which principles of the present disclosure can be implemented and serves mainly for contextualization of the presented teachings.

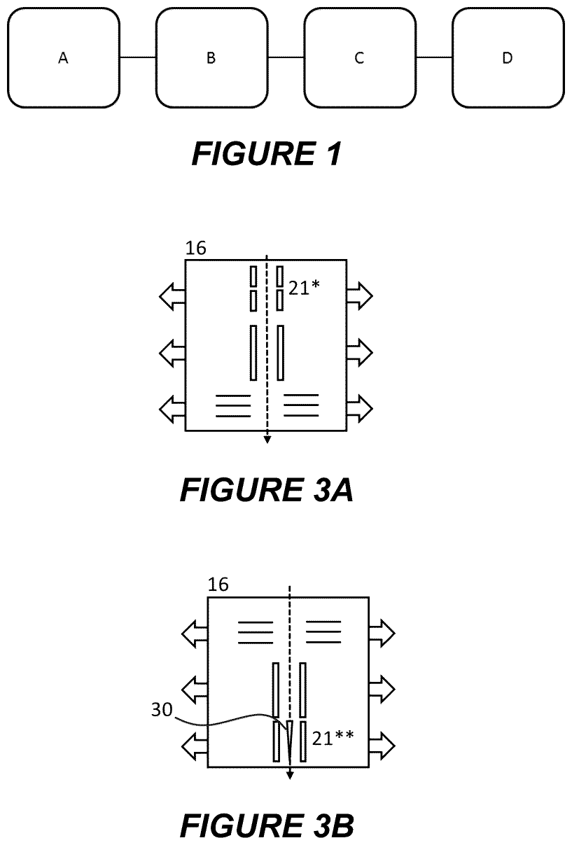

### DETAILED DESCRIPTION

While the invention has been shown and described with reference to a number of different embodiments thereof, it will be recognized by those skilled in the art that various changes in form and detail may be made herein without departing from the scope of the invention as defined by the appended claims.

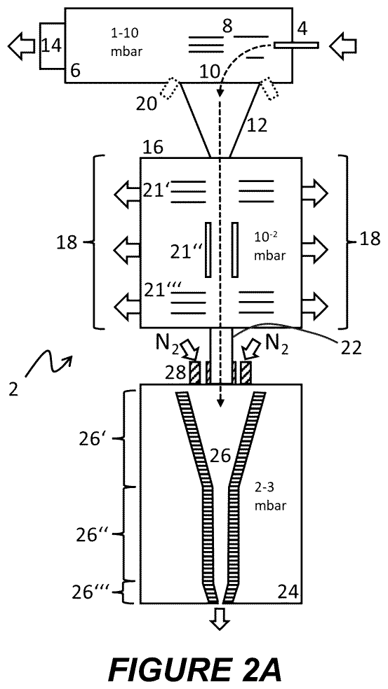

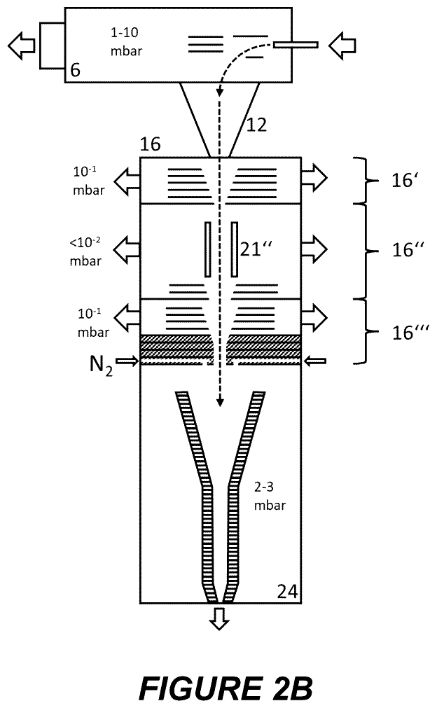

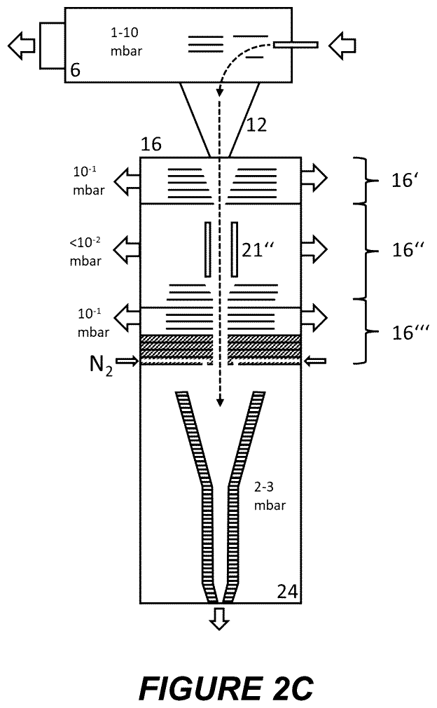

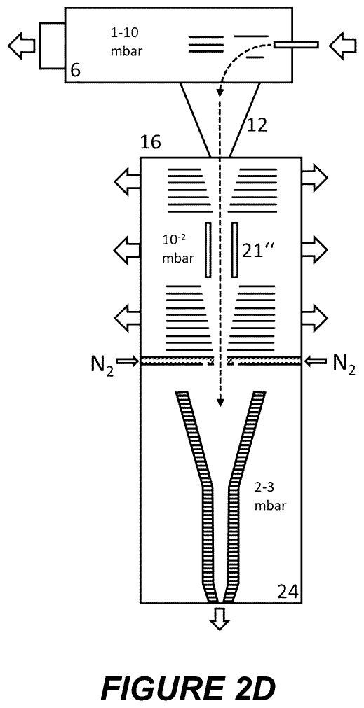

FIG. 2A shows an embodiment of an ion transmission apparatus (2). An ion source (not shown) is used to turn any type of sample material into gaseous ionic sample material. The ion source may be located in a separate chamber (not shown) and may be embodied, for example, as an electrospray ion source at substantially ambient or atmospheric pressure, ˜1000 millibar. A transfer capillary (4) may connect the ion source with, and may reach into a post-source vacuum chamber (6) which may be kept at a low rough vacuum pressure level which spans a range of between about 1 millibar and 10 millibar (Δp=˜9 millibar) within the post-source vacuum chamber (6). The post-source vacuum chamber (6) may comprise a plurality of deflector electrodes (8) which may be supplied with repelling DC and/or RF voltages, for instance. The deflector electrodes (8) and the DC and/or RF voltages supplied thereto may be configured such that ionic sample material takes a turn of about 90° (curved arrow 10) and is directed towards an exit of the post-source vacuum chamber and an RF ion funnel (12) connected thereto. Excess gas that originates from the ion source and has been introduced into the post-source vacuum chamber (6), such as clusters of water, solvent, and analytical ionic species, may stay largely unaffected by the assembly of deflector electrodes (8) and may proceed straight away within the post-source vacuum chamber (6) towards a venting or exhaust port (14) where it is pumped off. In so doing, gaseous species, such as water and solvent species as well as clusters, which may be remnants of the ionization process, and are of less analytical interest, can be separated from the gaseous ionic sample material and discarded.

The RF ion funnel (12) receives the deflected ionic sample material and may concentrate it into a fine beam which is well suited to be passed on through an opening, orifice or aperture in a wall of a downstream fine or medium vacuum chamber (16). The fine or medium vacuum chamber (16) may be comprehensively pumped to pressure levels of around 10⁻¹ millibar, 10⁻² millibar or lower (such as 10⁻⁴ millibar) at its center through a plurality of venting or pumping ports (18) arranged at side walls being aligned substantially perpendicular to the wall comprising the opening, orifice or aperture through which the gaseous ionic sample material enters.

At the interface of post-source vacuum chamber (6) and fine or medium vacuum chamber (16), including the RF ion funnel (12), the ion transmission apparatus (2) may comprise a gas inlet assembly (20) located substantially adjacent to the exit of the post-source vacuum chamber (6) and likewise adjacent to the entrance of the RF ion funnel (12). The gas inlet assembly (20) may be designed and configured to introduce gaseous matter into the post-source vacuum chamber (6) in order to establish gas-dynamic conditions and gas flows in the post-source vacuum chamber (6) which substantially prevent unwanted or undesired gaseous matter, apart from the gaseous ionic sample material of interest, from being transmitted through the RF ion funnel (12) and entering the fine or medium vacuum chamber (16) alongside with the ionic sample material of interest.

The fine or medium vacuum chamber (16) may contain a first stacked ring ion guide (21′) located opposite the entrance for, and initially receiving the gaseous ionic sample material, a central multipole rod assembly (21″), such as a quadrupole rod assembly, for transmitting ionic sample material from the first stacked ring ion guide (21′) towards a second stacked ring ion guide (21″′), located upstream and opposite an exit of the fine or medium vacuum chamber (16) for guiding ionic sample material through and out of the fine or medium vacuum chamber (16). The multipole rod assembly (21″) may be a quadrupole rod assembly which can be supplied with tunable RF and DC voltages which may cause a transmission characteristic of the multipole rod assembly (21″) to be switchable between a so called RF-only mode, in which the multipole rod assembly (21″) operates as a full mass range ion guide transmitting essentially all incoming masses or m/z species of ionic sample material, and one of a lowpass, highpass and bandpass mode in which the multipole rod assembly (21″) affords stable trajectories to ionic sample material passing it only for selected masses or m/z ratios or selected ranges thereof, either imposing an upper and lower limit or just imposing a limit at one end while being substantially unlimited at the other end of the mass or m/z scale.

The exit of the fine or medium vacuum chamber (16) may be fluidically connected to an assembly of transfer tubes or capillaries (22) which, in turn, may be connected at its other end to a separation vacuum chamber (24), and may have a constricted design in relation to the dimensions of the fine or medium vacuum chamber (16) and the separation vacuum chamber (24), which may allow for further assemblies being mounted adjacent and/or close to the entrance into the separation vacuum chamber (24) without suffering too many spatial constraints. The separation vacuum chamber (24) may contain a stacked ring ion guide assembly (26) which—in the presented example—may be monolithic in the sense that it does not include any interruptions along the common axis defined by the exit from the fine or medium vacuum chamber (16) and the entrance to the separation vacuum chamber (24) (and the one or more transfer capillaries or tubes, 22, therebetween). A first portion of the stacked ring ion guide (26) assembly may have a funnel design (26′), meaning that an inner aperture or width of the stacked rings through which ionic sample material passes on its way through the separation vacuum chamber (24) may become progressively smaller along the axis to further concentrate and collimate ionic sample material into a fine beam close to the axis. At the smallest funnel aperture, the stacked ring ion guide (26) may transition into an RF tunnel design (26″), meaning that an inner aperture or width of the stacked rings located there may remain substantially constant over a predetermined distance along the axis. After the predetermined distance, the stacked ring ion guide (26) may transition again into a funnel design (26″) to condition the transmitted ionic sample material into an even finer beam which can leave the separation vacuum chamber (24) through its exit.

Instead of a coaxial alignment of the one or more transfer capillaries or tubes (22) with the entrance of the stacked ring ion guide (26), as shown in FIG. 2A, it would likewise be possible to locate the funnel entrance (26′) of the stacked ring ion guide (26) offset from a symmetry center of the one or more transfer capillaries or tubes (22) in order to promote removing excess gaseous matter while still receiving and passing ionic sample material further on into subsequent portions of the stacked ring ion guide (26).

The tunnel section (26″) of the stacked ring ion guide (26) in the separation vacuum chamber (24) may be designed gastight in that gaps between the stacked rings are filled with electrically non-conductive, preferably chemically inert or inactive insulating material whereas the funnel sections (26′, 26″′) at the beginning and at the end of the stacked ring ion guide (26) may have a gas-dynamically open design to allow some electrically neutral gaseous matter to escape laterally. The tunnel section (26″) may be embodied as a trapped ion mobility separator which accumulates ionic sample material driven by a substantially laminar flow of gaseous matter against an electric field barrier and then elutes it fractionated into parcels of different ion mobility or collision cross section (CCS) to a subsequent mass analysis chamber or fragmentation, activation or reaction chamber (not shown) in a sequence of ionic sample material having low ion mobility eluting first and ionic sample material having high ion mobility eluting later. The tunnel section (26″) may also be embodied as a TIMS having parallel accumulation capacity, as disclosed in the patent application publication US 2016/0231275 A1 which is incorporated by reference herein in its entirety.

Adjacent to the entrance of the separation vacuum chamber (24), and at the end of the one or more transfer capillaries or tubes (22) pointing to it, another gas inlet assembly (28) may be located in a constriction space between the fine or medium vacuum chamber (16) and the downstream separation vacuum chamber (24), left open by the narrow design of the one or more transfer capillaries or tubes (22). The gas inlet assembly (28) may include a plurality of nozzles being substantially aligned parallel to the axis of fine or medium vacuum chamber exit and separation vacuum chamber entrance. A chemically inert or inactive gas, such as molecular nitrogen N2 at a low temperature, may be injected into the separation vacuum chamber (24) in order to generate fluid-dynamic conditions which largely or substantially prevent backflow of gaseous matter from the separation vacuum chamber (24) at substantially higher pressure through the one or more transfer capillaries or tubes (22) into the fine or medium vacuum chamber (16) at lower pressure in relation thereto. In so doing, the introduction of gaseous matter may at least partially, if not largely, compensate disadvantageous static pressure differentials by countering them with dynamic pressure differentials, and perturbation of the propagation of ionic sample material which may be caused by backflow of gaseous matter can thus be mitigated or even be resolved almost completely. Such course of action improves the acceptance conditions at the stacked ring ion guide (26) located within the separation vacuum chamber (24), thus increasing the transmission efficiency of ionic sample material.

Simulations of the operation of an embodiment of a gas transmission apparatus (2) as shown in FIG. 2A, having a gas inlet assembly (28) at the separation vacuum chamber (24) comprising four nozzles which are located symmetrically around the one or more transfer capillaries or tubes (22) and substantially axially aligned, using COMSOL™, have shown that a reduction in backflow of gaseous matter of about 25% can be achieved, compared to an embodiment in which additional gaseous matter is introduced into the separation vacuum chamber (24) simply substantially perpendicular to an ion propagation path, such as may be known from curtain gas arrangements in the Prior Art.

FIG. 2B illustrates a variant of the embodiment from FIG. 2A, having a different design of the fine or medium vacuum chamber (16) and a different fluidic coupling between the first exit and the second entrance. In order to avoid unnecessary repetition, emphasis will be placed in the following on explaining only those parts of the variant in detail that differ from the previously described embodiment while not further elaborating on those parts which agree between variant and previous embodiment.

The fine or medium vacuum chamber (16) may be divided into three pressure sub-stages (16′, 16″, 16″′) along the axis from the first entrance towards the first exit. A first pressure sub-stage (16′), maintained at about 1-10⁻² millibar, such as 10₋₁ millibar, may contain a stacked ring RF ion funnel which receives at its wide end ionic sample material that has passed the external RF ion funnel (12) and focuses it toward its narrow end where it passes an orifice in an intra-chamber sub-stage boundary wall whence it enters a second sub-stage (16″), maintained at less than about 10⁻² millibar, such as down to 10⁻⁵ millibar. A multipole rod assembly (21″), such as a quadrupole mass filter, located within the second sub-stage (16″) may either filter the received ionic sample material according to the set pass characteristic or transmit the ionic sample material largely unaffected in an RF-only mode. Upon exiting the multipole rod assembly (21″) or quadrupole mass filter, the ionic sample material may be received by another stacked ring RF ion funnel at its wide end and focused toward its narrow end to pass through an orifice of another sub-stage boundary wall where it enters a third sub-stage (16″), maintained at about 10⁻¹ millibar, similar to the pressure level of the first sub-stage (16′). The third sub-stage (16″) may contain a stacked ring RF ion funnel-ion tunnel assembly which receives ionic sample material at its wide RF ion funnel end and transmits it downstream at its narrow RF ion tunnel end into the separation vacuum chamber (24). While the gaps between some of the stacked ring electrodes at an upstream portion of the stacked ring RF ion funnel-ion tunnel assembly may be unfilled and ready to allow excess gas to be vented and pumped off, the gaps between some of the stacked ring electrodes at a downstream portion of the stacked ring RF ion funnel-ion tunnel assembly may be filled with a chemically inert and electrically neutral material, such as polytetrafluoroethylene (PTFE) or polyether ether ketone (PEEK), as indicated by the hatched area, so as to form a boundary interface, having a comparatively narrow opening, between the third sub-stage (16″′) of the fine or medium vacuum chamber (16) and the downstream separation vacuum chamber (24). A gap between the last one of the stacked rings of the stacked ring RF ion funnel-ion tunnel assembly and a chamber wall, which is likewise filled with electrically neutral material, may feature an embedded supply conduit of gas, such as for receiving molecular nitrogen N₂, directed from radially outward to radially inward where the supplied gas may exit the supply conduit through an annular nozzle opening, or an arrangement of several individual nozzles, and may be discharged in a direction substantially along the central axis into the separation vacuum chamber (24).

The stacked ring electrodes of the various stacked ring electrode assemblies located within the three sub-stages (16′, 16″, 16″′) of the fine or medium vacuum chamber (16) may have monolithic design, i.e., receiving only a single phase of RF or AC voltage per ring and axial position, or may be of multipolar design, i.e., comprising perimeter segments which may receive various phases of an RF or AC voltage, such as to render a quadrupolar, hexapolar, octopolar radial confinement field or the like, and likewise various DC voltage biases per ring and axial position to drive ions axially onwards or hold them back. The intra-chamber boundary walls between the various sub-stages (16′, 16″, 16″′) may be supplied with DC voltages only, RF or AC voltages only, or with combined RF or AC and DC voltages.

Compared to the embodiment of FIG. 2A, the variant shown in FIG. 2B encompasses an axially substantially seamless transition from the third sub-stage (16″′) of the fine or medium vacuum chamber (16) to the subsequent separation vacuum chamber (24), manifesting itself in a single orifice, opening or aperture. Guiding ionic sample material toward the exit of the fine or medium vacuum chamber (16) using stacked ring electrode assemblies supplied with RF or AC and DC voltages facilitates radial confinement of the ionic sample material along its way through such stacked ring electrode assembly and further allows the establishing of axial potential gradients as a driving force to move the ionic sample material forward along the axis.

FIG. 2C shows another variant of the fine or medium vacuum chamber (16) having three sub-stages (16′, 16″, 16″′), similar to the one shown in FIG. 2B. The main difference is that the third sub-stage (16″′) in FIG. 2C features solely an RF ion tunnel, i.e., an assembly of stacked ring electrodes the inner widths of which do not change along the axis but maintain a same inner diameter, passable by ionic sample material, up to the transition into the downstream separation vacuum chamber (24)

FIG. 2D illustrates a further variant of the fine or medium vacuum chamber (16) which is more related to the one in FIG. 2A in that it is not divided into sub-stages and is maintained at about 10⁻² millibar. Instead it features a central multipole rod assembly (21″), such as a quadrupole mass filter, which is sandwiched by a first stacked ring RF ion funnel upstream, which focuses ionic sample material received from the external RF ion funnel (12) to a comparatively small beam diameter before transmitting it to the multipole rod assembly (21″), and a second stacked ring RF ion funnel downstream, which receives ionic sample material that has passed the multipole rod assembly at its wide end and focuses it to a smaller beam diameter before transmitting it to the subsequent separation vacuum chamber (24). In the example shown, the second RF ion funnel comprises open gaps between its stacked ring electrodes for venting and pumping off excess gas. Only the gap between the last one of the stacked ring electrodes of the second RF ion funnel and the divider wall between the vacuum chambers (16, 24) encompasses a supply conduit of gas which discharges the gas into the separation vacuum chamber (24) as has been described before with reference to the variant of FIG. 2B.

FIG. 3A schematically shows a variant of the one or more RF ion guides contained within the fine or medium vacuum chamber (16). Instead of a first stacked ring ion guide as depicted in FIG. 2A, the fine or medium vacuum chamber (16) may comprise a multipole rod assembly (21*) having one or more rod segments. The rods of the multipole rod assembly may be segmented in order to allow the application of varying DC potentials to the individual segments which can assist in establishing a potential gradient along a longitudinal axis of the multipole rod assembly (21*), driving or propelling ionic sample material in a desired direction. Multipole rod assemblies, in particular, of low order, such as quadrupole rod assemblies, may facilitate radial confinement of ionic sample material in a pseudo-potential well comparatively close to the axis of the assembly.

FIG. 3B schematically illustrates another variant of the one or more RF ion guides located within the fine or medium vacuum chamber (16). Instead of a second stacked ring ion guide as depicted in FIG. 2A, the fine or medium vacuum chamber (16) may comprise a multipole rod assembly (21**) having one or more additional electrodes (30) located in or outside close to the gap(s) between two pole rods of the multipole rod assembly (21**). The one or more additional electrodes (30) may have a tapered design and may be aligned with a same axis as the pole rods of the multipole rod assembly (21**), which may facilitate establishing a potential gradient along its longitudinal extension within the notional confines of the multipole rod assembly (21**) where ionic sample material propagates. The one or more additional electrodes (30) may optionally be segmented (not shown).

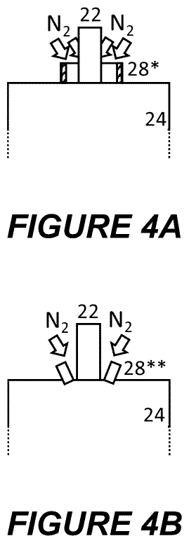

FIG. 4A schematically depicts a variant of the gas inlet assembly (28) located adjacent to the entrance of the separation vacuum chamber (24). Instead of a plurality of individual nozzles each one of which injects an individual beam of additional gaseous matter into the separation vacuum chamber as shown in FIG. 2A, the modified gas inlet assembly (28*) may comprise an annular or ring-shaped nozzle located concentrically around the one or more transfer capillaries or tubes (22). Such design affords more comprehensive coverage of the circumferential angular range around the entrance to the separation vacuum chamber (24) for injecting gaseous matter and may help in preventing or mitigating turbulent conditions at the point of introduction of gaseous matter within the separation vacuum chamber (24).

FIG. 4B exemplarily shows another variant of the gas inlet assembly located adjacent to the entrance of the separation vacuum chamber (24). Instead of being aligned strictly parallel to a common straight axis defined by the exit of the upstream fine or medium vacuum chamber (16), the entrance to the downstream separation chamber (24), and the one or more transfer capillaries or tubes (22) in between, as illustrated in FIG. 2A and FIG. 4A, the modified gas inlet assembly (28**), represented here exemplarily by a plurality of individual nozzles, may be configured such that gaseous matter is introduced into the separation vacuum chamber (24) at an acute angle in relation to the central axis. Such design may help in establishing a continuous or steady or even substantially laminar gas flow within and through the separation vacuum chamber (24) and/or the one or more RF ion guides contained therein, as the case may be.

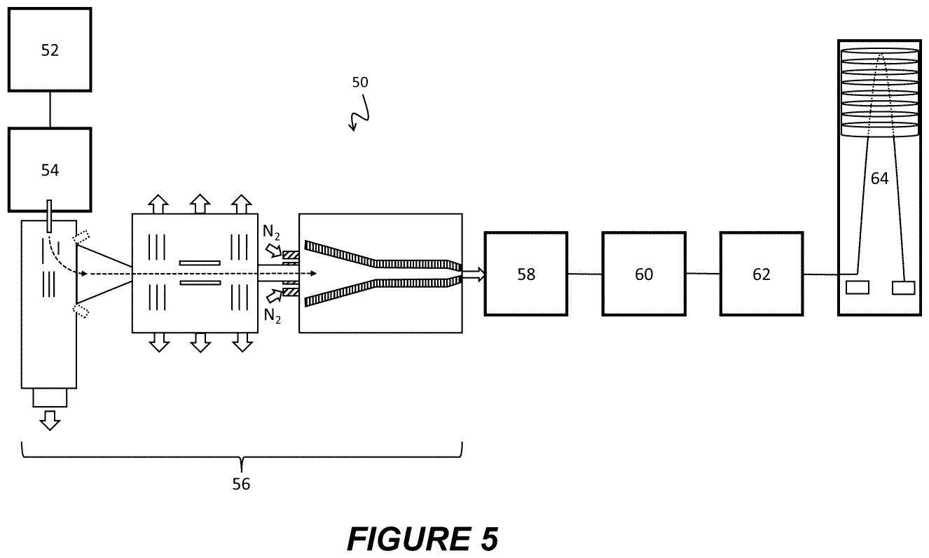

FIG. 5 is a schematic representation of a possible combined ion mobility-mass spectrometer (50) in which principles of the present disclosure may be implemented.

A sample may be separated first in a chromatographic stage, as indicated at (52). The chromatographic stage may comprise a liquid chromatography stage having a column encompassing a suitable stationary phase through which the sample dissolved in a suitable mobile phase is flowed. The result may be a sequence of subsequently eluting chromatographic peaks at characteristic retention times, dependent on the chromatographic conditions applied.

The eluent of the chromatographic stage may be passed on to an ion source, as indicated at (54), which may turn the sample molecules contained in the eluent peaks into gaseous ionic matter. The ion source may be an electrospray ion source which exploits a high voltage difference established at a spray nozzle in relation to a counter electrode to nebulize and ionize a liquid sample, such as one eluting from a liquid chromatography column. In general, ions may be generated for example by using spray ionization (e.g., electrospray (ESI) or thermal spray), desorption ionization (e.g., matrix-assisted laser/desorption ionization (MALDI) or secondary ion mass spectrometry (SIMS) ionization), chemical ionization (CI), photoionization (PI), electron impact ionization (EI), gas-discharge ionization, and the like.

The gaseous ionic sample material may be collected and funneled into a well collimated beam facilitating its efficient transfer into a transmission and ion mobility separation stage, as indicated under (56). The apparatus for transmitting gaseous ionic sample material may be embodied according to any one of the examples provided in the present disclosure. The ion mobility separation stage may exploit the interaction of the gaseous ionic sample material with a moving or stagnant gas while being acted upon by an electric field, either held constant or varied over time. By way of example, the ion mobility separation stage may be designed and configured according to principles of trapped ion mobility separation (TIMS). The disclosure U.S. Pat. No. 7,838,826 B1, which is incorporated herein by reference in its entirety, gives examples of TIMS separation stages. The result of ion mobility separation may be a sequence of subsequently eluting ionic mobility peaks at characteristic times, dependent on the conditions of the mobility separation applied. Other suitable types of gas phase ion mobility separators may encompass drift tube ion mobility separators (DTIMS), travelling wave ion mobility separators (TWIMS), and gas phase ion mobility filters like field asymmetric ion mobility separators (FAIMS).

The eluted mobility peaks can pass an ion guide stage, as indicated at (58), which may serve to pass ionic sample material through a pressure differential between comparatively high pressure in the ion mobility separation stage and lower pressure maintained in the subsequent stages for further gas phase ion handling and manipulation. Such ion guide stage may encompass various ion guides, e.g., multipole rod assemblies and/or stacked ring ion guides, as hereinbefore described.

A filter stage, as indicated at (60), can follow the ion guide stage (58). The filter stage may comprise a mass filter such as a quadrupole mass filter that facilitates transmission of gaseous ionic sample material in a broadband or precursor screening mode, which aims at sorting out as few ionic species as possible or, in other words, transmits as many of the incoming ionic species as possible, and any one of a bandpass filter mode, highpass filter mode and lowpass filter mode, the aim of which is to reduce a transmission window to a comparatively narrow mass or mass-to-charge ratio (m/z) range, thereby entailing dismissing ionic species not falling in this transmission window. The broadband or precursor screening mode and any one of the filter modes may be alternated in (quick) succession using tunable RF and/or DC voltages supplied to the mass filter.

A fragmentation stage, as indicated at (62), can follow the filter stage (60). The fragmentation stage may comprise an ion guide filled with a collision gas and further be equipped with electrodes which facilitate the switching of an acceleration voltage for pulling gaseous ionic sample material at high speed into the collision gas in order to induce dissociation. Precursor ionic species selected from the gaseous ionic sample material can be fragmented into a plurality of characteristic fragment ionic species. In general, gaseous ionic sample material can for example be fragmented in the fragmentation stage by collision induced dissociation (CID), surface induced dissociation (SID), photo-dissociation (PD), electron capture dissociation (ECD), electron transfer dissociation (ETD), collisional activation after electron transfer dissociation (ETcD), activation concurrent with electron transfer dissociation (AI-ETD), fragmentation by reactions with highly excited or radical neutral particles, and the like.

The gaseous ionic sample material emanating from the collision cell may be passed on to a mass analyzer stage, as indicated at (64). The mass analyzer stage may take the form of a reflector time-of-flight (rTOF) stage featuring orthogonal ion injection into the TOF flight tube. At the end of the curved flight path within the flight tube the ionic sample material may be registered by an impact detector, such as a secondary electron multiplier detector. The result may be a spectrum that plots ionic abundance, such as ionic intensity, over a molecular weight or mass-related scale, such as the time of flight. Together with the information from the chromatographic stage (52) and the transmission and ion mobility separation stage (56), the spectrometry data can be presented in different maps, such as 3D plots where each axis corresponds to a scale of the physical-chemical properties (i) retention time from the chromatographic stage (52), (ii) gas phase ion mobility or related property from the ion mobility separation stage (56), and (iii) mass or mass-to-charge ratio or related property from the mass analyzer stage (64), while the abundance of signal peaks can be represented by color or another suitable graphical feature.

The invention has been shown and described above with reference to a number of different embodiments thereof. It will be understood, however, by a person skilled in the art that various aspects or details of the invention may be changed, or various aspects or details of different embodiments may be arbitrarily combined, if practicable, without departing from the scope of the invention. It is possible, for instance, to implement apparatuses, and execute methods according to principles of the present disclosure in embodiments of mass spectrometers as shown in patent application publication US 2020/0381241 A1 which is cited in the introduction and incorporated herein by reference in its entirety. Generally, the foregoing description is for the purpose of illustration only, and not for the purpose of limiting the invention which is defined solely by the appended claims, including any equivalent implementations, as the case may be.

1. An apparatus for transmitting gaseous ionic sample material for subsequent analysis, comprising:
a first vacuum chamber encompassing a first entrance through which gaseous matter including ionic sample material is introduced, a first exit through which gaseous matter including ionic sample material leaves, and one or more first RF ion guides for receiving and guiding ionic sample material along its way from the first entrance to the first exit, the first vacuum chamber being kept in a first pressure range,
a second vacuum chamber encompassing a second entrance through which gaseous matter including ionic sample material leaving the first vacuum chamber is introduced, the second entrance being fluidically coupled to the first exit and defining an axis, a second exit through which gaseous matter including ionic sample material leaves, and one or more second RF ion guides for receiving and guiding ionic sample material along its way from the second entrance to the second exit, the second vacuum chamber being kept in a second pressure range which is substantially higher than the first pressure range, and
a first gas inlet assembly located substantially adjacent to the second entrance and designed and configured to introduce gaseous matter, which does not originate from the first vacuum chamber, in a direction substantially along the axis into the second vacuum chamber.

2. The apparatus according to claim 1, wherein the first gas inlet assembly encompasses one or more nozzles.

3. The apparatus according to claim 2, wherein the one or more nozzles encompass one of (i) a plurality of individual nozzles and (ii) an annular or ring-shaped nozzle.

4. The apparatus according to claim 3, wherein the plurality of individual nozzles is aligned such that gaseous matter is introduced at an angle of less than 60° to the axis.

5. The apparatus according to claim 1, wherein the first gas inlet assembly is designed and configured to introduce gaseous matter substantially one of (i) coaxially and (ii) concentrically with the axis.

6. The apparatus according to claim 1, further comprising one or more transfer tubes or capillaries fluidically coupling the second entrance with the first exit.

7. The apparatus according to claim 1, wherein the first pressure range is on the order of 10⁻¹ millibar and less, and the second pressure range is a single digit-millibar range situated between 0.2 and 50 millibar.

8. The apparatus according to claim 1, wherein the one or more second RF ion guides encompass one or more ion mobility separators.

9. The apparatus according to claim 8, wherein the one or more ion mobility separators encompass one or more trapped ion mobility separators.

10. The apparatus according to claim 1, wherein the one or more second RF ion guides encompass a substantially gastight design.

11. The apparatus according to claim 1, further comprising a mass balance system being operated such that a mass balance of gaseous matter being introduced into the second vacuum chamber is maintained to generate a substantially continuous or steady flow of gaseous matter within the second vacuum chamber.

12. The apparatus according to claim 11, wherein the substantially continuous or steady flow of gaseous matter is one of (i) section-wise and (ii) completely substantially laminar along its way within the second vacuum chamber.

13. The apparatus according to claim 11, wherein the substantially continuous or steady flow of gaseous matter is generated within the one or more second RF ion guides.

14. The apparatus according to claim 1, wherein the one or more second RF ion guides encompass one or more ion guides which have at least one of (i) an RF funnel design and (ii) an RF tunnel design.

15. The apparatus according to claim 1, wherein the one or more second RF ion guides encompass one or more stacked ring ion guides.

16. The apparatus according to claim 1, wherein the first vacuum chamber encompasses one or more venting ports for extracting excess gaseous matter.

17. The apparatus according to claim 1, wherein the one or more first RF ion guides encompass at least one of (i) a stacked ring ion guide and (ii) an RF multipole assembly.

18. The apparatus according to claim 17, wherein the stacked ring ion guide encompasses one or more electrode rings having multipolar design.

19. The apparatus according to claim 17, wherein the RF multipole assembly encompasses one or more segmented multipole rods.

20. The apparatus according to claim 17, wherein the RF multipole assembly encompasses one or more additional electrodes to establish an electric potential gradient along its length.

21. The apparatus according to claim 1, wherein at least one of (i) the one or more first RF ion guides and (ii) the one or more second RF ion guides are substantially aligned along the axis.

22. The apparatus according to claim 1, wherein one or more electric potentials are applied to at least one of (i) the one or more first RF ion guides and (ii) the one or more second RF ion guides, such that ionic sample material is driven in a direction substantially from the first vacuum chamber to the second vacuum chamber.

23. The apparatus according to claim 1, further comprising one or more trapping diaphragms or lenses being located in the first vacuum chamber at least one of at (i) the first entrance, (ii) the first exit, and (iii) a position between the first entrance and the first exit, the one or more trapping diaphragms or lenses being temporarily supplied with one or more electric trapping potentials which substantially hinder the propagation of ionic sample material.

24. The apparatus according to claim 1, further comprising at least one of a (i) mass analyzer and (ii) fragmentation, activation or reaction cell, being in fluidic communication with the second exit.

25. The apparatus according to claim 1, further comprising a third vacuum chamber encompassing a third entrance through which gaseous matter including ionic sample material is introduced, a third exit, being fluidically coupled to the first entrance, through which gaseous matter including ionic sample material leaves, one or more venting ports for extracting excess gaseous matter, and one or more deflectors for redirecting and guiding ionic sample material along its way from the third entrance to the third exit, the third vacuum chamber being substantially kept in a third pressure range which is substantially higher than the first pressure range.

26. The apparatus according to claim 25, further comprising an RF funnel fluidically coupling the third exit with the first entrance for guiding and conditioning ionic sample material.

27. The apparatus according to claim 25, wherein the third pressure range is a single digit-millibar range situated between 0.2 and 50 millibar.

28. The apparatus according to claim 25, wherein the third entrance encompasses one or more transfer tubes or capillaries.

29. The apparatus according to claim 25, wherein the one or more deflectors are designed and configured such as to deflect ionic sample material by an angle of more than 45° from a direction of introduction towards the third exit.

30. The apparatus according to any claim 25, where the third entrance is in fluidic communication with an ion source.

31. The apparatus according to claim 25, further comprising a second gas inlet assembly located substantially adjacent to the third exit and designed and configured to introduce gaseous matter into the third vacuum chamber.

32. A method for transmitting gaseous ionic sample material for subsequent analysis, comprising:
introducing gaseous matter including ionic sample material into a first vacuum chamber through its entrance,
receiving and guiding ionic sample material along its way from the entrance to an exit of the first vacuum chamber using one or more first RF ion guides within the first vacuum chamber,
releasing gaseous matter including ionic sample material through the exit of the first vacuum chamber, in so doing, keeping the first vacuum chamber in a first pressure range,
introducing gaseous matter including ionic sample material being released from the first vacuum chamber into a second vacuum chamber through its entrance, being fluidically coupled to the exit of the first vacuum chamber and defining an axis,
receiving and guiding ionic sample material along its way from the entrance to an exit of the second vacuum chamber using one or more second RF ion guides within the second vacuum chamber,
releasing gaseous matter including ionic sample material through the exit of the second vacuum chamber, in so doing, keeping the second vacuum chamber in a second pressure range which is substantially higher than the first pressure range, and
introducing gaseous matter, which does not originate from the first vacuum chamber, at a position substantially adjacent to the entrance of the second vacuum chamber in a direction substantially along the axis into the second vacuum chamber.
